(19) United States
(12) Patent Application Publication
(10) Pub. No.: US 2012/0205430 A1
(43) Pub. Date: Aug. 16, 2012

(54) DISPOSABLE INSULATED CONTAINER AND METHOD OF MAKING

(76) Inventor: James C. Dickert, Burr Ridge, IL (US)

(21) Appl. No.: 13/372,853

(22) Filed: Feb. 14, 2012

Related U.S. Application Data
(60) Provisional application No. 61/463,032, filed on Feb. 14, 2011.

(51) Int. Cl. B65D 3/00; B65D 25/00; B31B 3/00

(52) U.S. Cl. 229/403; 493/52; 220/738

(57) ABSTRACT

A disposable cup having an applied wrap or sleeve that at least partially covers the circumference and/or depth of the cup body. The disposable cup is made of typical cup making materials and the wrap is made from one of several materials, such as embossed paperboard, corrugated paper, plastic or foam. In a preferred embodiment of the present invention, the wrap is attached to the cup at the time of the cup manufacture. The wrap has a shape that preferably partially covers the basic cup wall and is sufficient to provide thermal protection, and preferably, an attractive appearance.

### CROSS-REFERENCE TO RELATED APPLICATION

This application claims the priority of provisional application Ser. No. 61/463,032, filed Feb. 14, 2011, which application is incorporated herein in its entirety by reference thereto.

### FIELD OF THE INVENTION

This invention relates generally to disposable containers and deals more particularly with an improved disposable insulated container particularly adapted to contain hot liquids and a method for making such containers.

### BACKGROUND OF THE INVENTION

It is believed that when a hot liquid, such as a beverage (e.g., coffee, tea and hot chocolate), soup and the like, is introduced at up to between 190 and 200° F. (a recommended serving temperature) into a paper cup, the outer surface of the cup attains a temperature of approximately 140 to 150 degrees Fahrenheit within about 30 seconds. Such temperatures are extremely uncomfortable to a person holding the cup.

The traditional approach to protecting the person holding the cup from these elevated temperatures is to use an insulated cup or provide a separate sleeve for the cup. Insulated cups made from plastic material have enjoyed great popularity, particularly in the fast food industry. However, such containers, and particularly those made from plastic materials are not environmentally friendly. For example, such containers are frequently not biodegradable or are made from substantially more than the minimum amount of material necessary to make the cup. In either case, such cups present disposal problems. For example, local regulations may require separating plastic cups from other waste materials, Moreover, by using more than the minimum amount of material necessary, the cups may increase the amount of material to be buried in a limited landfill. Additionally, many of the disposable cups made from plastic material are relatively fragile and break easily. Disposable insulated paper cups have been advanced as more environmentally friendly. Such cups are generally either of a dual wall type construction, or have an inner container and an outer insulating layer that covers the entire circumference of the inner container.

Examples of the first type of such cups are provided by U.S. Pat. No. 5,460,323 to Titus and U.S. Pat. No. 5,226,585 to Varano. This type of cup typically is made from two blanks, one on top of the other. The two blanks are assembled to form side walls, one inside the other separated by an insulating air chamber between the two side walls. The insulating air chamber extends annularly between the spaced side walls of the container.

Examples of the second type of cups are provided by U.S. Pat. No. 5,454,484 to Chelossi. This type of arrangement comprises a cup and a separate cup holder or sleeve. Typically, the cup holder or sleeve is formed from a sheet, the distal ends of which are connected. These sleeves are made from a scored sheet that encompasses the entire circumference of the cup body. Such sleeves are typically held in place by interlock slits to lock the sleeve to the cup with friction, an adhesive, or a combination thereof. Cup sleeve structures constituting pre-assembled, glued sleeves have also been proposed which do not require interlock slits to lock the sleeve to the cup, as for example, Chelossi, U.S. Pat. No. 5,454,484 and Dickert, the instant inventor in U.S. Pat. No. 5,826,786.

In the case of the pre-assembled, glued sleeves, the exposed outer portions tend to cause jamming when a top assembly is nested within another cup of a like kind If the sleeves are added to the cups by the customer in the retail environment, the beverage retailer must provide separate cups and cup holders which requires additional counter space and causes the customer or merchant to spend time assembling the sleeve, thereby slowing processing of customers. In any event, such cup sleeves are relatively expensive to manufacture, in part, because the cup sleeve must cover the full circumference of the cup while the user only needs the insulation in a relatively small portion of the cup. Gluing or slow lock assembly of the sleeve is required. Moreover, the pre-applied sleeve full wrap and overlays are expensive and overall of minimal effectiveness.

Other outer sleeve constructions, such as disclosed in U.S. Pat. Nos. 6,196,454; 6,378,766; and 6,422,456, require a third layer of insulating material.

Accordingly, it is an objective of the present invention to provide an improved disposable insulated cup or container for low-cost manufacture which may be nested without difficulty within another cup or container of like kind, and which closely resembles a conventional smooth surface cup or container while possessing insulating qualities better than those of comparable cups or containers and which eliminate the outer sleeve overlap. It is a further objective of the invention to eliminate the third layer of insulating material. It is also an objective of the present invention to provide a means of producing an improved insulating cup which uses less materials in its manufacture. It is yet a further objective of the present invention to provide a disposable cup that is more environmentally friendly than conventional plastic cups.

### SUMMARY OF THE INVENTION

The present invention provides a wrap or sleeve that partially covers the cup body. The wrap or sleeve is typically made from conventional cup making materials, such as uncoated solid bleached paperboard or can be made from recycled paperboard which is then embossed as described in U.S. Pat. No. 5,826,786, which is incorporated in its entirety herein by reference, or scored, single faced corrugated paper, insulated paper such as filter paper, plastic or foam. In a preferred embodiment of the present invention, the wrap or sleeve is attached to the cup at the time of the cup manufacture. It is desired that the wrap is shaped to conform to the shape of the outer surface of the cup to which the wrap is to be attached. The wrap can have any suitable shape for achieving the desired appearance and utility.

In one embodiment of the present invention, the wrap of the present invention is applied to the cup body in a manner analogous to the application of a cup handle to a conventional disposable handled cup.

It is preferred that the wrap provides thermal protection on an area of the outer surface of the cup sufficient to accommodate an average size hand. Generally, the wrap covers approximately two thirds of the circumference of the cup body, but can cover up to 100%, but in that case without any overlap. Moreover, the wrap is typically between about 2 and 3 inches wide covering only part of the cup wall vertically. The applied wrap can cover a small up to the complete area of the cup body circumference, as desired. This construction provides for a possible substantial reduction in material required as compared to the constructions which cover the entirety of both the circumference and height of the cup body.

In accordance with the present invention a disposable insulated cup or container is provided which includes a carrier having an open upper end and including a side wall formed from a blank, a bottom wall, and means for retaining the bottom wall in substantially liquid tight engagement with the side wall. A partial wrap or sleeve coaxially surrounds a substantial portion, but not all, of a section of the outer surface of said side wall. The partial wrap has upper and lower edges as well as distal edges. In one embodiment of the present invention, means are provided for adhering at least the upper and lower marginal portions of the wrap to a section of the outer surface of the side wall. It is possible for the wrap to cover up to 100% of the outer surface of the side wall (either circumference and/or height), but in no case with any overlap. Multiple piece wraps are possible but are more expensive than the one piece construction and manufacture.

### BRIEF DESCRIPTION OF THE DRAWINGS

FIG. 1 is a top plan view of a container and insulating wrap according to a preferred embodiment of the present invention;

FIG. 2 is a side elevational view of a disposable insulated container embodying the present invention;

FIG. 3 is a top plan view of a blank used to form a container for one embodiment of the present invention;

FIG. 4 is a top plan detail view of a portion of another disposable insulated container of the present invention;

FIG. 5 is a top plan view of an embossed blank used to form part of a container for another embodiment of the present invention;

FIG. 6 is a side elevational view of a disposable insulated container for another embodiment of the present invention;

FIG. 7 is a vertical cross-sectional view of a portion of a disposable insulated container of the present invention; and

FIG. 8 is a horizontal cross-sectional view of a portion of a disposable insulated container of the present invention.

FIG. 9 is a view of the outer cup wrap with a wavy or similar interrupted lower edge.

### DETAILED DESCRIPTION OF THE PREFERRED EMBODIMENTS AND METHOD

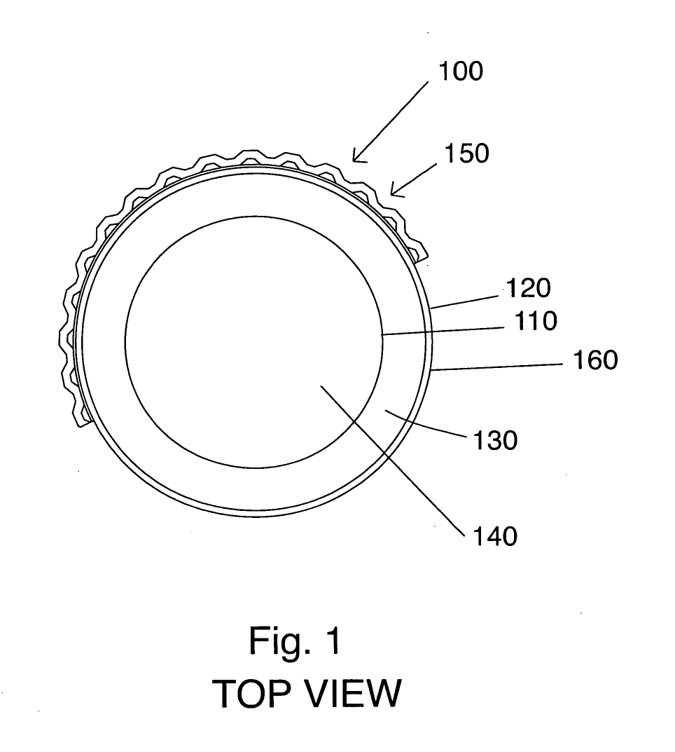

Turning now to the drawings, FIGS. 1 & 2 illustrate an insulated disposable container embodying the present invention which is indicated by general reference numeral 100. Container 100 essentially comprises a smooth wall inner cup 160 and an outer wrap 150. Illustrated container 100 is made from conventional cup forming materials. Typically, the partial wrap is made from blanks made from materials that include conventional or recycled cup making embossed paperboard, single faced corrugated paper, insulating paper, plastic, and foam (such as polystyrene). Virgin solid bleach stock having a single ply coating of polyethylene on its inner surface is a preferred cup forming material.

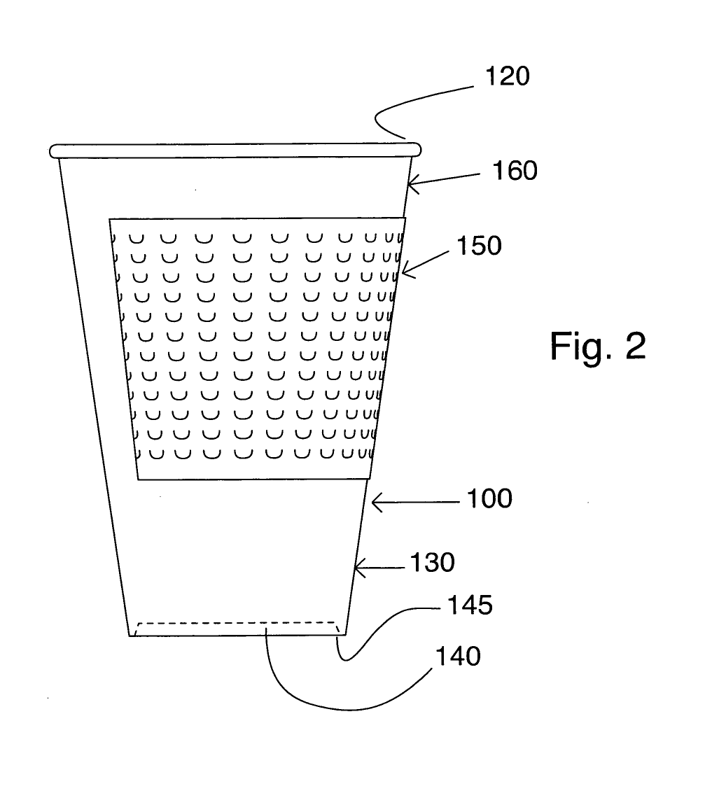

Typically, inner cup 160 has a frustoconical configuration which facilitates nesting within another cup of like kind Inner cup 160 has a sidewall 130 formed by joining opposite marginal end portions of a sidewall blank in overlapping face-to-face relationship to each other to form seal 135. The upper end portion of the sidewall blank may be rolled outward to form an annular bead 120 of generally circular shape as shown in FIG. 2. Alternatively, the upper end portion of the sidewall blank may be turned outwardly and downwardly and flattened to form a rim which surrounds the upper end of the cup 160.

A circular bottom wall 140 is made from another blank, preferably a paper blank. Bottom wall 140 is connected to sidewall 130 in a substantially liquid tight engagement. It is also preferred that bottom wall 140 is spaced upwardly from the lower edge of sidewall 130 so as to insulate the beverage from any surface upon which the cup may be placed.

Bottom wall 140 preferably includes a depending annular skirt 145. Skirt 145 is attached in face-to-face relation to the inner surface of sidewall 130 at bottom edge 110. In an alternative embodiment, the lower marginal portion of the sidewall 130 is rolled and formed inwardly and upwardly into face-to-face relationship with the inner surface of skirt 145.

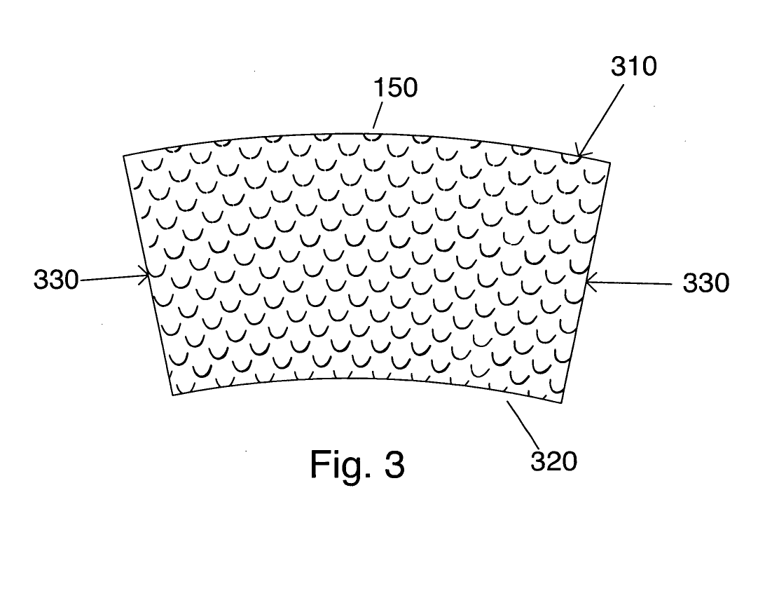

FIG. 3 depicts a blank, preferably of paperboard, used to form a container having a generally frustoconical shape.

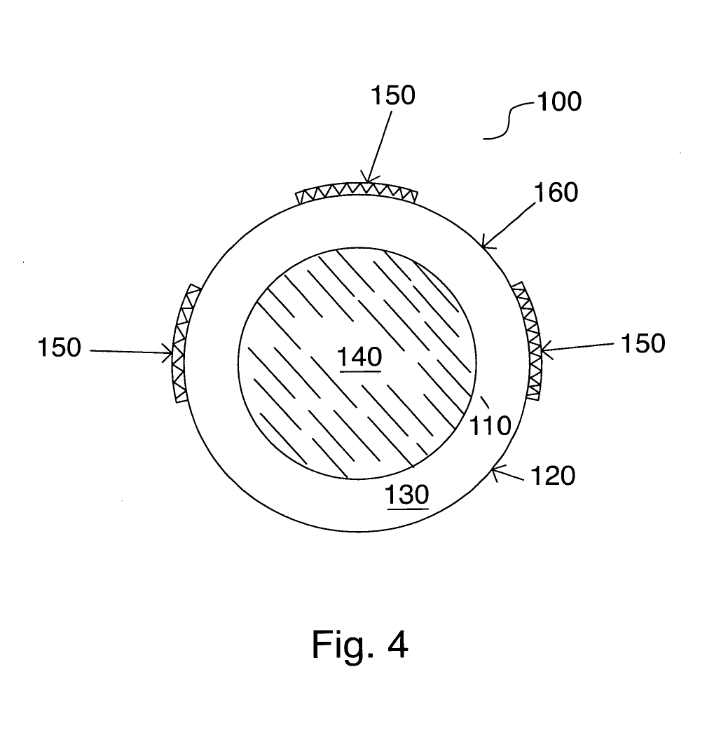

The wrap typically covers between about 40 and 100 percent of the outer circumference of the cup. In most, instances, the wrap will cover slightly more than the portion of the cup which is contacted by an average hand. This result is normally obtained by use of a one piece wrap, although in alternative embodiments of the present invention, the wrap may be discontinuous and consists of two or more pieces. FIG. 4 illustrates a discontinuous wrap embodiment of the present invention. As shown in FIG. 4, the wrap consists of three discrete pieces 150. These pieces are positioned so that the customer's thumb rests on the first piece, the customer's palm on the second, and the customer's fingertips on the third. In a two piece embodiment of the present invention, typically the customer's thumb rests on the first piece and the customer's fingertips are on the second. This two-piece structure is intuitive to a user and is particularly economic to construct.

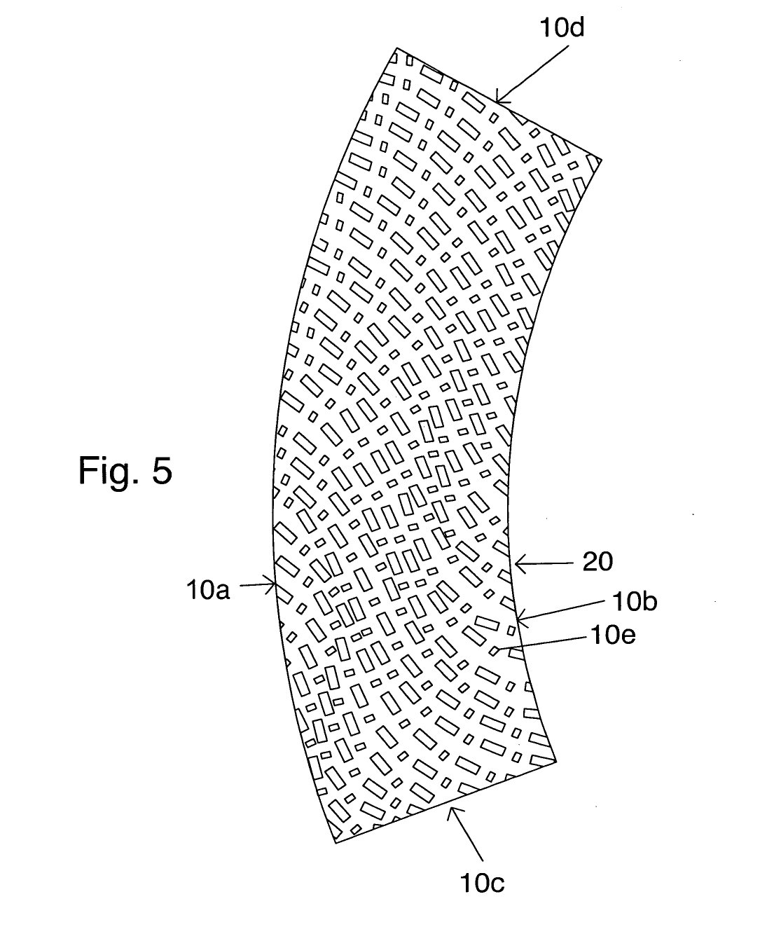

FIG. 5 depicts an insulating blank 20 having positive and negative embossure, such as embossure 10e. Because of the frustoconical shape of beverage cups, wrap upper edge 10a is seen to be longer than wrap lower edge 10b. Side edges 10c and 10d can meet at a butt seam or not as desired and in any case will define the width of insulated wrap 20. This embossed wrap material provided excellent air movement between the wrap and cup wall and is produced with better economics than three-piece structures or two-piece structures that do not allow air flow and collapse in use, thus causing direct hand contact with the heated cup wall.

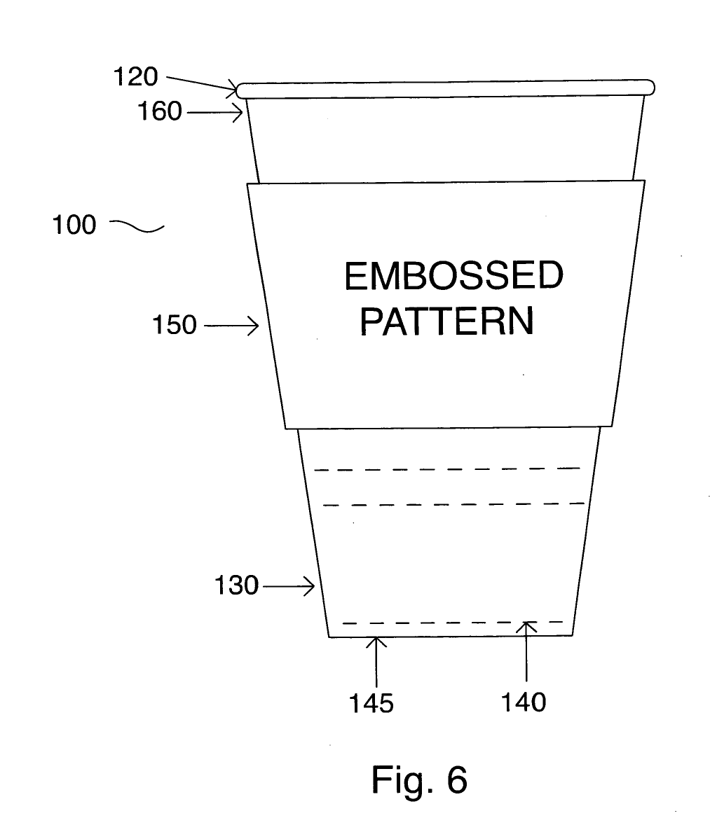

FIG. 6 illustrates an insulated disposable container embodying the present invention which is indicated by general reference numeral 100. Container 100 essentially comprises a smooth wall inner cup 160 and an outer wrap 150. Illustrated container 100 is made from conventional cup forming materials. Cup 160 also has lower portion 130, upper rim bead 120 and bottom wall and rim seals 140 and 145. In additional embodiments for cup 30 having insulating wrap 20, the latter may be alternatively lengthened or widened for alternative coverage areas as may be desired.

Typically, the partial wrap is made from blanks made from materials that include conventional or recycled cup making embossed paperboard, single faced corrugated paper, insulating paper, plastic, and foam (such as polystyrene foam). Virgin solid bleach stock having a single ply coating of polyethylene on its inner surface is a preferred cup forming material. Fluted linerboard is a preferred material for the wrap and may be advantageously used as substitute for the embossed paperboard. Both, however, allow excellent air flow for cooling the underlying cup.

Typically, inner cup 160 has a frustoconical configuration which facilitates nesting within another cup of like kind Inner cup 160 has a sidewall 130 formed by joining opposite marginal end portions of a sidewall blank in overlapping face-to-face relationship to each other to form a seal. The upper end portion of the sidewall blank maybe rolled outward to form an annular bead 120 of generally circular cross-section as shown in FIG. 5. Alternatively, the upper end portion of the sidewall blank may be turned outwardly and downwardly and flattened to form a rim which surrounds the upper end of the cup 160.

A circular bottom wall 140 is made from another blank, preferably a paper blank. Bottom wall 140 is connected to sidewall 130 in a substantially liquid tight engagement. It is also preferred that bottom wall 140 is spaced upwardly from the lower edge of sidewall 130 so as to insulate the beverage from any surface upon which the cup may be placed. Bottom wall 140 preferably includes a depending annular skirt 145. Skirt 145 is attached in face-to-face relation to the inner surface of sidewall 130 at bottom edge 110. In an alternative embodiment, the lower marginal portion of the sidewall 130 is rolled and formed inwardly and upwardly into face-to-face relationship with the inner surface of skirt 145.

While the sidewall blank, the bottom wall, the means for retaining the bottom wall in substantial liquid tight engagement with the sidewall and the partial wrap may be formed from any conventional material, it is preferred that these structures are made from conventional biodegradable materials. In any event, the sidewall blank, the bottom wall, and the means for retaining the bottom wall in substantial liquid tight engagement with the sidewall are all formed from materials approved for contact with foodstuffs.

Preferably, the above-enumerated materials are formed or wrapped to conform to the configuration of the basic cup.

As stated above, the wrap typically and preferably covers between about 40 and 100 percent of the outer circumference of the cup. In most instances, the wrap will cover slightly more than the portion of the cup which is contacted by an average hand. This result is normally obtained by use of a one piece wrap, although in alternative embodiments of the present invention, the wrap may be discontinuous and consists of two or more pieces.

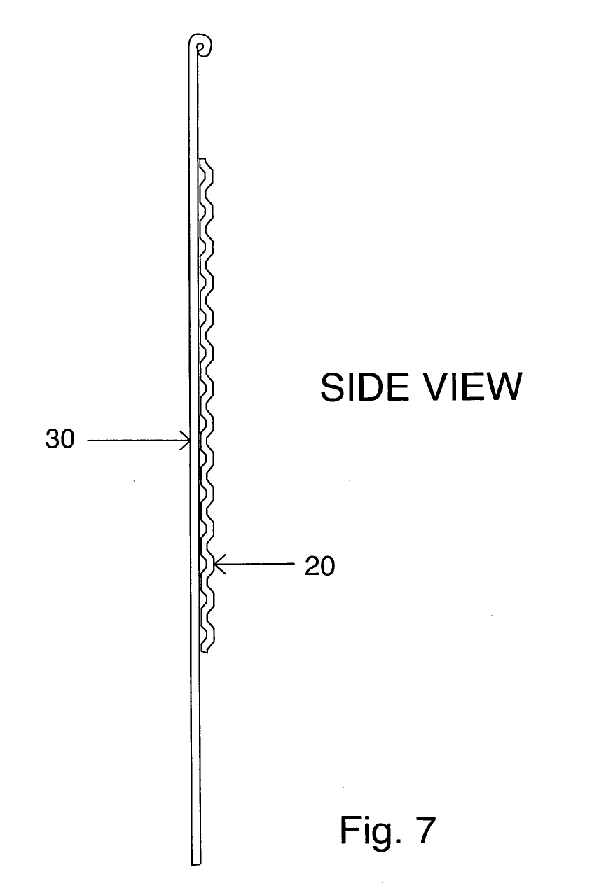

FIG. 7 is a side or vertical cross-sectional detail of a portion of the disposable insulated container of the present invention. In FIG. 7, inner cup wall 30 has been positioned with respect to outer insulting wrap 20, at a place providing optimum customer comfort. In this view, the positive and negative embossures are readily seen which provide insulating air space under the wrap and a satisfactory tactile feel for the customer's hand. The tactile feel also is manifested by a cooler feel, the result of the space created between the wrap material and the user's fingers and hand enhancing heat tolerance.

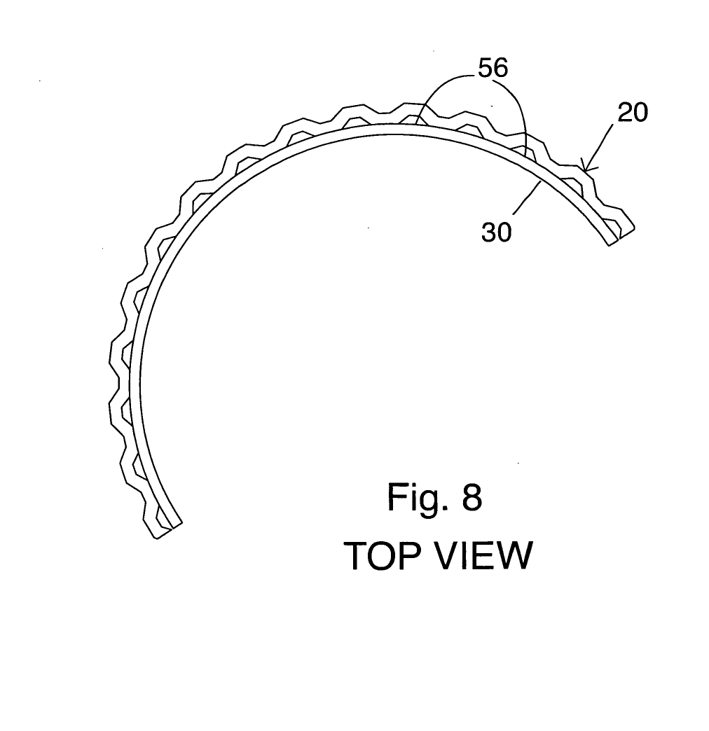

FIG. 8 is a horizontal cross-sectional detail of a portion of the disposable insulated container of the present invention. In FIG. 8, inner cup wall 30 has been positioned with respect to outer insulting wrap 20, at a place providing optimum customer comfort. In this view, the positive and negative embossures are readily seen which provide insulating air space 56 under the wrap.

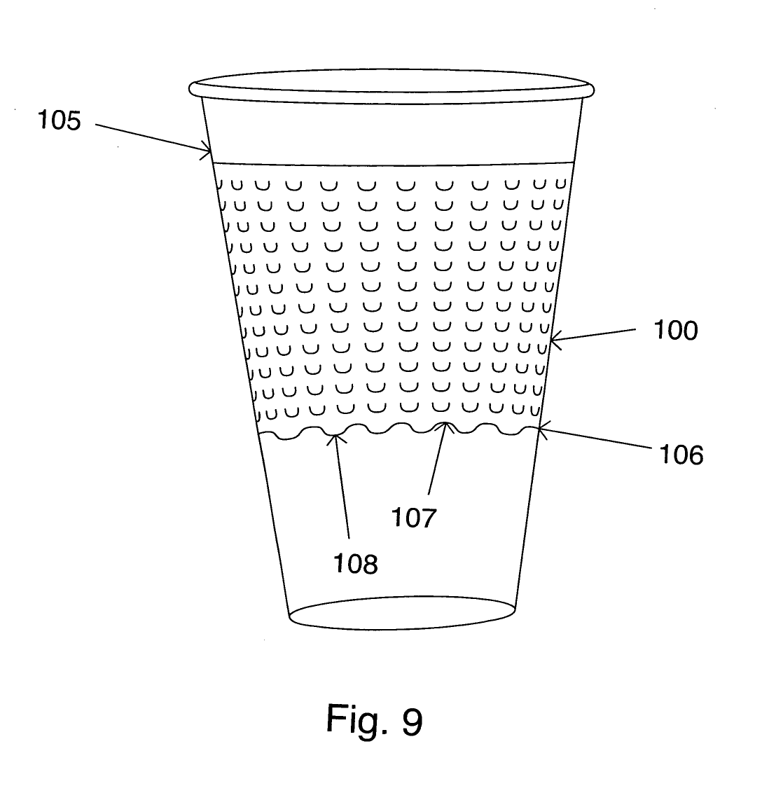

As shown in FIG. 9, the bottom edge of the cup wrap incorporates a wavy or cut pattern, for example of triangles. This feature, particularly when the wrap is to be positioned close to the lower end of the cup, serves to counteract the tendency of a stack of wrapped cups to stick together when nesting with the result that denesting is made difficult. The wavy and triangular cut on the bottom of the cup further aids in applying the sleeve to the cup as it assists in expansion of the sleeve to adjust to the dimensions of the bottom of the cup.

The wrap (three-piece embodiment) is positioned so that the customer's thumb rests on a first position, the customer's palm on a second, and the customer's fingertips on a third. In a two piece embodiment of the present invention, typically the customer's thumb rests on the first piece and the customer's fingertips are on the second.

The wrap can be attached to the cup by conventional means. For example, the wrap may be attached to the cup by a conventional adhesive such as a contact or heat sensitive adhesive. However, the adhesive must be stable under conditions of elevated heat, i.e., the wrap must stay attached to the cup when the outer surface of the cup reaches temperatures of about 200° F. Alternatively, the wrap may be attached to the cup by conventional heat seal such as commonly used with a poly coated stock. For example, a polyethylene coat may be applied to the wrap and cup to hold the two together.

In a preferred embodiment of the present invention, the wrap is made from a printed and/or embossed paperboard. In such an embodiment, the manufacturer can display information to be conveyed to the consumer on the wrap. By placing such information on the wrap instead of on the cup itself, the manufacturer has more freedom in positioning the informative material on the cup without regard to whether the wrap covers the information the manufacturer wishes to convey.

When corrugated material is used to make the wrap, it is preferred that the corrugated material has a single face. Further, fluted paperboard can be substituted for single face or embossed paperboard.

When the wrap is made from a flexible material, it may be provided in either roll form or as flat shaped sheets. In roll form, the material may be printed, embossed, and/or cut to shape prior to being attached to the cup. In a preferred embodiment, the preparation of the wrap from a roll form is performed substantially immediately before the wrap is applied to the cup. In blank form, the wrap is permanently applied to the cup, preferably just after the cup is made.

In another embodiment of the present invention, the wrap is adhered to the outer surface of a conventional cold cup.

Heretofore, a separate piece of material, typically a piece of die-cut paperboard, was applied at the time of cup manufacturer to a cup to form a fold out handle. This attachment was adhesively applied or welded by a poly coating applied to the surface of the handle assembly and the cup body so as to form a handled cup. The equipment used to attach such a handle could be used to attach the wrap of the present invention.

When the wrap is embossed, it is preferred that the embossure patterns are positive/negative with selected patterns on the front and back surfaces. Embossure patterns may be selected from a limitless number of designs, including custom designs selected by the beverage retailer for the disposable cups with the wraps of the present invention. The embossed outer surface of the wrap may provide a pleasant tactile feel and grip to the customer as well as aesthetic appearance and improved thermal insulation, A non-skid or thermally actuated interior coating can also be applied to the interior surface of the wrap during the printing of the wrap to provide a means for adhering the wrap to the cup.

The embossing patterns can take the form of nubs and depressions formed between mutual calendar rolls so as to form complementary patterns which are mirror images of each other. U.S. Pat. No. 5,826,786 describes such an example. However it is preferred that non-mirror images are used, such as those embossed by male/female embossing rolls that emboss into each surface so as to provide different insulating, gripping, and/or aesthetic effect to the wraps of the present invention.

In one embodiment of the present invention, the insulated disposable cup of the present invention is prepared by starting with a sidewall blank which is die-cut from blank sheet or a web of stock material. This sidewall blank may be printed in any conventional manner prior to its assembly. The blank is rolled into a frustoconical shape, and the over lapping ends are adhered to each other in a face-to-face manner with a substantially liquid tight adhesive suitable for use in food applications.

Concurrently a bottom wall is also die-cut from a blank sheet or web of stock material. The bottom wall blank is adhered to the narrower end of the frustoconical structure, also with a substantially liquid tight adhesive to form a closed bottom of the cup. Additionally, a wrap blank is die-cut from a blank sheet or web of stock material.

Typically the wrap blank is coated with an adhesive along its upper and lower edges, and applied to the assembled cup so as to form the partially covered insulated disposable cup of the present invention. Preferably, the wrap blank is applied to the cup at the site of the cup manufacture. In a further embodiment of the present invention, the wrap blank having a heat sensitive adhesive is distributed separately and the customer applies the wrap to the cup containing a hot beverage before consuming the beverage.

Each of the steps used in the method of the present invention relies upon procedures conventional in the paper products industry and is not described further. The steps of printing, embossing, die-cutting, scoring, folding, and gluing can be done in one production process, or in sequential or separate fabrication steps, as is known in the art. The paperboard material can be a selected kraft, news, or white-lined recycled or virgin paperboard. Other types of materials, such as foam board, or other laminate combinations may be used to make this product.

In a further embodiment of the present invention, the exterior surface of the wrap may include a non-skid coating, such as a silica layer. The wrap may be made of other materials, such as fiber mixtures including paper fiber, non-woven materials, and plastics.

Numerous modifications and variations may be made in light of the principles of the invention disclosed herein. The invention and all modifications and variations thereof are included present design.

1. A disposable cup having:
(a) a sidewall;
(b) a bottom wall;
(c) a means for sealing said sidewall to said bottom wall in substantially liquid tight engagement; and
(d) a partial wrap that coaxially surrounds a substantial portion, but not all, of the outer circumference and/or depth of said sidewall.

2. The disposable cup of claim 1 in which said wrap only covers part of the depth and circumference of said cup.

3. The disposable cup of claim 1 in which said wrap may have a printed matter on its outer surface.

4. The disposable cup of claim 1 in which said wrap is embossed paperboard.

5. The disposable cup of claim 1 in which said wrap is foam.

6. The disposable cup of claim 1 in which said wrap is a single-faced, corrugated material.

7. The disposable cup of claim 1 in which said wrap is fluted linerboard.

8. The disposable cup of claim 1 in which said wrap is virgin solid bleach stock.

9. The disposable cup of claim 1 in which said wrap is adhered to said cup body by a heat-sensitive adhesive.

10. The disposable cup of claim 1 in which said wrap is adhered to said cup body by a polymer coating.

11. The disposable cup of claim 10 in which said polymer coating is polyethylene.

12. The disposable cup of claim 1 in which said wrap is adhered to said cup body by a cold adhesive.

13. An undivided plurality of wraps according to claim 1, each adapted to cover part of the outer circumference and depth of a cup sidewall.

14. A method of making an insulated disposable cup comprising the steps of:
(a) forming a disposable cup; and
(b) covering at least part of the circumference and/or depth of the outer surface of said disposable cup with an insulating material.

15. The method of making an insulated disposable cup of claim 13 wherein said disposable cup is covered with said insulating material before said cup is packaged for distribution.

16. A cup sleeve adapted to encompass a partial portion of the outer circumference and/or depth of the side wall of a disposable cup comprising a sleeve made of a member selected from the group consisting of paperboard, embossed paperboard, corrugated paper, plastic and film.

17. A cup sleeve according to claim 16 wherein said sleeve is adapted to cover between about 40 to 100% of the outer circumference of the cup.

18. A cup sleeve according to claim 16 wherein the bottom edge of said sleeve has a wavy or triangle cut-out appearance.

19. A cup sleeve according to claim 16 wherein said sleeve has advertising or graphic design printed upon at least a part of the visible outer surface of said cup sleeve.

20. A cup sleeve according to claim 16 wherein said sleeve is adapted to cover approximately 2-3 inches of the cup wall vertically.
